(19) United States
(12) Patent Application Publication
(10) Pub. No.: US 2006/0003084 A1
(43) Pub. Date: Jan. 5, 2006

(54) Protection of metal-based substrates with hematite-containing coatings

(76) Inventor: Thinh T. Nguyen, Onex (CH)

Correspondence Address: J R Deshmukh, 458 Cherry Hill Road, Princeton, NJ, 08540, US

(21) Appl. No.: 10/526,914

(22) PCT Filed: Aug. 14, 2003
(86) PCT No.: PCT/IB03/03654

§ 371 Date: Mar. 7, 2005

(30) Foreign Application Priority Data
Aug. 20, 2002 (IB) 02/03392

(51) Int. Cl. B05D 5/12

(52) U.S. Cl. 427/58

(57) ABSTRACT

A method of forming a dense and crack-free hematite-containing protective layer on a metal-based substrate for use in a high temperature oxidising and/or corrosive environment comprises: (I) applying onto the substrate a mass of particles comprising hematite (Fe₂O₃) and: (a) iron metal (Fe) with a weight ratio Fe/Fe₂O₃ of at least 0.3 and preferably below 2, in particular in the range from 0.8 to 1.4; and/or (b) ferrous oxide (FeO) with a weight ratio FeO/Fe₂O₃ of at least 0.35 and preferably below 2.5, in particular in the range from 0.9 to 1.7; and (II) consolidating the applied mass of particles to form the hematite-containing protective layer by heat treating the mass of particles to: 1) sinter the hematite to form a porous sintered hematite matrix; and 2) oxidise into hematite (Fe₂O₃) the iron metal (Fe) and the ferrous oxide (FeO) to fill the sintered hematite matrix. The mechanical, electrical and electrochemical properties of the protective layer can be improved by using additives, such as oxides of titanium, zirconium and/or copper. Typically the protected substrate can be used in a cell for the electrowinning of a metal such as aluminium.

### FIELD OF THE INVENTION

This invention relates to a method of manufacturing non-carbon anodes for use in aluminium electrowinning cells as well as other oxidation resistant components.

### BACKGROUND ART

Using non-carbon anodes for the electrowinning of aluminium should drastically improve the aluminium production process by reducing pollution and the cost of aluminium production. Many attempts have been made to use oxide anodes, cermet anodes and metal-based anodes for aluminium production, however they were never adopted by the aluminium industry.

For the dissolution of the raw material, usually alumina, a highly aggressive fluoride-based electrolyte, such as cryolite, is required.

The materials having the greatest resistance to oxidation are metal oxides which are all to some extent soluble in cryolite. Oxides are also poorly electrically conductive, therefore, to avoid substantial ohmic losses and high cell voltages, the use of oxides should be minimal in the manufacture of anodes. Whenever possible, a good conductive material should be utilised for the anode core, whereas the surface of the anode is preferably made of an oxide having a high electrocatalytic activity.

Several patents disclose the use of an electrically conductive metal anode core with an oxide-based active outer part, in particular U.S. Pat. Nos. 4,956,069, 4,960,494, 5,069,771 (all Nguyen/Lazouni/Doan), U.S. Pat. No. 6,077,415 (Duruz/de Nora), U.S. Pat. No. 6,103,090 (de Nora), U.S. Pat. No. 6,113,758 (de Nora/Duruz) and U.S. Pat. No. 6,248,227 (de Nora/Duruz), as well as PCT publications WO00/06803 (Duruz/de Nora/Crottaz), WO00/06804 (Crottaz/Duruz), WO00/40783 (de Nora/Duruz), WO01/42534 (de Nora/Duruz) and WO01/42536 (Nguyen/Duruz/de Nora).

U.S. Pat. Nos. 4,039,401 and 4,173,518 (both Yamada/Hashimoto/Horinouchi) disclose multiple oxides for use as electrochemically active anode material for aluminium electrowinning. The multiple oxides include inter-alia oxides of iron, nickel, titanium and yttrium, such as NiFe₂O₄ or TiFe₂O₄, in the '401 patent, and oxides of yttrium, iron, titanium and tantalum, such as Fe₂O₃.Ta₂O₅, in the '518 patent. The multiple oxides are produced by sintering their constitutive single oxides and then they are crushed and applied onto a metal substrate (titanium, nickel or copper) by spraying or dipping. Alternatively, the multiple oxides can be produced by electroplating onto the metal substrate the constitutive metals of the multiple oxides followed by an oxidation treatment.

Likewise U.S. Pat. Nos. 4,374,050 and 4,374,761 (both Ray) disclose non-stoichiometric multiple oxides for use as electrochemically active anode material for aluminium electrowinning. The multiple oxides include inter-alia oxides of nickel, titanium, tantalum, yttrium and iron, in particular nickel-iron oxides. The multiple oxides are produced by sintering their constitutive single oxides and then they can be cladded onto a metal substrate.

WO99/36591 (de Nora), WO99/36593 and WO99/36594 (both Duruz/de Nora) disclose sintered multiple oxide coatings applied onto a metal substrate from a slurry containing particulate of the multiple oxides in a colloidal and/or inorganic polymeric binder, in particular colloidal or polymeric alumina, ceria, lithia, magnesia, silica, thoria, yttria, zirconia, tin oxide or zinc oxide. The multiple oxides include ferrites of cobalt, copper, chromium, manganese, nickel and zinc. It is mentioned that the coating can be obtained by reacting precursors thereof among themselves or with constituents of the substrate.

U.S. Pat. No. 6,372,119 and WO01/31091 (both Ray/Liu/Weirauch) disclose a cermet made from sintered particles of nickel, iron and cobalt oxides and of metallic copper and silver possibly alloyed with cobalt, nickel, iron, aluminium, tin, niobium, tantalum, chromium molybdenum or tungsten. The particles can be applied as a coating onto an anode substrate and sintered thereon to form an anode for the electrowinning of aluminium.

These non-carbon anodes have not as yet been commercially and industrially applied and there is still a need for metal-based anodes for aluminium production.

### SUMMARY OF THE INVENTION

The present invention relates to a method of forming a dense and crack-free hematite-containing protective layer on a metal-based substrate, in particular a metallic substrate, for use in a high temperature oxidising and/or corrosive environment. The method comprises: (I) applying onto the substrate a mass of particles comprising hematite (Fe₂O₃) and at least one of: (a) iron metal (Fe) with a weight ratio Fe/Fe₂O₃ of at least 0.3 and preferably below 2, in particular in the range from 0.8 to 1.4; or (b) ferrous oxide (FeO) with a weight ratio FeO/Fe₂O₃ of at least 0.35 and preferably below 2.5, in particular in the range from 0.9 to 1.7; or (c) iron metal (Fe) and ferrous oxide (FeO), with weight ratios Fe/Fe₂O₃ and FeO/Fe₂O₃ that are in pro rata with the ratios of (a) and (b); and (II) consolidating the applied mass of particles to form the hematite-containing protective layer by heat treating the mass of particles to: 1) oxidise when present the iron metal (Fe) into ferrous oxide (FeO); 2) sinter the hematite to form a porous sintered hematite matrix; and 3) oxidise into hematite (Fe₂O₃) the ferrous oxide (FeO) present in the mass of particles as such and/or in the form of the oxidised iron metal, to fill the sintered hematite matrix.

In other words, when the mass of particles comprises Fe in an amount (weight) A1, and FeO in an amount A2, the mass of particles of the invention should also comprise an amount of at least 0.3×A1+0.35×A2 of Fe₂O₃ and preferably no more than 2×A1+2.5×A2 of Fe₂O₃ to provide weight ratios of Fe, FeO and Fe₂O₃ that fall within the combination of the above broad ranges given separately for the ratios Fe/Fe₂O₃ (from 0.3 to preferably 2) and FeO/Fe₂O₃ (from 0.35 to preferably 2.5).

For the purpose of achieving the invention, iron metal will usually be provided in the form of iron metal particles and/or possibly surface oxidised iron metal particles. Ferrous oxide and hematite can be provided in the form of ferrous oxide particles and hematite particles respectively, and/or in the form of magnetite (Fe₃O₄=FeO.Fe₂O₃) particles.

The formation of hematite from the ferrous oxide results in a volume expansion such that it fills the porous sintered hematite matrix and inhibits formation of cracks by contraction of the pores of the hematite matrix during sintering. The method thus provides a hematite-containing protective layer that is dense and substantially crack-free and that inhibits diffusion from and to the metal-based substrate, in particular it prevents diffusion of constituents, such as nickel, from the substrate.

It has been observed that when the weight ratio Fe/Fe₂O₃ is at 0.3, 90% of the contraction cracks in the protective layer can be eliminated compared to a layer produced from a mass of particles which does not contain metallic iron. When the weight ratio Fe/Fe₂O₃ is at or above 0.75 or 0.8, all contraction cracks can be eliminated. Above a weight ratio of 1.4 or 1.5, the protective layer is still dense and crack-free, however a satisfactory oxidation of Fe and FeO into Fe₂O₃, i.e. without significant incomplete oxidation of Fe/FeO into Fe₂O₃, is more difficult to achieve even though it is still possible. Above a weight ratio Fe/Fe₂O₃ of 2, a satisfactory oxidation of Fe and FeO into Fe₂O₃ is even more difficult to obtain. Such a high Fe concentration can nevertheless be contemplated for applications for which the presence of incompletely oxidised iron in the protective layer is not detrimental. The same considerations apply of course equally to the presence of FeO or a combination of Fe and FeO in the mass of particles.

Best results have been obtained with starting compositions of the mass of particles having a weight ratio Fe/Fe₂O₃ from 1 to 1.2 or a weight ratio FeO/Fe₂O₃ from 1.45 to 1.8 or, when both Fe and FeO are used in the mass of particles, a pro rata combination thereof.

The protective layer should contain sufficient iron oxide to form a sintered iron oxide matrix that possibly contains minor amounts of further elements, such as additives, dopants and catalysts. Usually, the layer contains at least 50 weight % iron oxide, typically at least 75 weight % oxide and preferably at least 85 weight or even at least 90 weight %.

The electrical/electrochemical properties of the protective layer can be improved with additives, such as oxides of titanium, yttrium, ytterbium, tantalum, manganese, zinc, zirconium, cerium and nickel and/or heat-convertible precursors thereof. The additive(s) can be present in the protective layer in a total amount of 1 to 50 weight %. Usually, it is sufficient for the additive(s) to be present in a catalytic amount to achieve the electrical/electrochemical effect, in particular in a total amount of 1 to 30 weight % or even 5 to 15 weight %. Limiting the amount of additives also reduces the risk of contamination of the protective layer's environment during use, e.g. an electrolyte of a metal electrowinning cell.

The protective layer can further comprise at least one metal selected from Cu, Ag, Pd, Pt, Co, Cr, Al, Ga, Ge, Hf, In, Ir, Mo, Mn, Nb, Os, Re, Rh, Ru, Se, Si, Sn, Ti, V, W, Li, Ca, Ce and Nb and/or an oxide thereof which can be added to the mass of particles as such, e.g. as particles, or as a precursor, e.g. as particles or in solution, for example a salt such as a chloride, sulfate, nitrate, chlorate or perchlorate, or a metal organic compound such as an alkoxide, formate or acetate. Such a metal and/or oxide can be present in the protective layer in a total amount of 1 to 15 weight %, preferably from 1 to 5 or 10 weight %.

Minor amounts of copper or copper oxides, i.e. up to 5 or 10 weight %, improve the electrical conductivity of the protective layer and diffusion of iron oxide (and possibly other oxides) during the sintering of the protective layer. This leads to the production of more conductive and denser protective layers than without the use of copper metal and/or oxides.

The mass of particles can be made of particles that are smaller than 75 micron, preferably smaller than 50 micron, in particular from 5 to 45 micron.

The metal-based substrate can be metallic, ceramic, a cermet of a surface-oxidised metal.

Usually, the metal-based substrate comprises at least one metal selected from chromium, cobalt, hafnium, iron, molybdenum, nickel, copper, niobium, platinum, silicon, tantalum, titanium, tungsten, vanadium, yttrium and zirconium or an oxide thereof. For instance, the metal-based substrate comprises an alloy of iron, in particular an iron alloy containing nickel and/or cobalt.

Advantageously, the method of the invention comprises oxidising the surface of a metallic substrate to form an integral anchorage layer thereon to which the protective layer is bonded by sintering during heat treatment, in particular an integral layer containing an oxide of iron and/or another metal, such as nickel, that is sintered during the heat treatment with iron oxide from the mass of particles. Further details on such an anchoring of the protective layer are disclosed in PCT/IB03/01479 (Nguyen/de Nora).

When used for aluminium electrowinning, the protected metal-based substrate preferably contains at least one metal selected from nickel, iron, cobalt, copper, aluminium and yttrium. Suitable alloys for such a metal-based substrate are disclosed in U.S. Pat. No. 6,372,099 (Duruz/de Nora), and WO00/06803 (Duruz/de Nora/Crottaz), WO00/06804 (Crottaz/Duruz), WO01/42534 (de Nora/Duruz), WO01/42536 (Duruz/Nguyen/de Nora), WO02/083991 (Nguyen/de Nora), WO03/014420 (Nguyen/Duruz/de Nora) and PCT/IB03/00964 (Nguyen/de Nora).

The mass of particles can be applied onto the substrate as a slurry. Such a slurry may comprise an organic binder which is at least partly volatilised during sintering, in particular a binder selected from polyvinyl alcohol, polyvinyl acetate, polyacrylic acid, hydroxy propyl methyl cellulose, polyethylene glycol, ethylene glycol, hexanol, butyl benzyl phthalate and ammonium polymethacrylate. The slurry may also comprise an inorganic binder, in particular a colloid, such as a colloid selected from lithia, beryllium oxide, magnesia, alumina, silica, titania, vanadium oxide, chromium oxide, manganese oxide, iron oxide, gallium oxide, yttria, zirconia, niobium oxide, molybdenum oxide, ruthenia, indium oxide, tin oxide, tantalum oxide, tungsten oxide, thallium oxide, ceria, hafnia and thoria, and precursors thereof such as hydroxides, nitrates, acetates and formates thereof, all in the form of colloids; and/or an inorganic polymer, such as a polymer selected from lithia, beryllium oxide, alumina, silica, titania, chromium oxide, iron oxide, nickel oxide, gallium oxide, zirconia, niobium oxide, ruthenia, indium oxide, tin oxide, hafnia, tantalum oxide, ceria and thoria, and precursors thereof such as hydroxides, nitrates, acetates and formates thereof, all in the form of inorganic polymers. Such an inorganic binder may be sintered during the heat treatment with an oxide of an anchorage layer which is integral with the metal-based substrate to bind the protective layer to the metal-based substrate.

Typically, the mass of particles is consolidated on the substrate by heat treatment at a temperature in the range from 800° to 1400° C., in particular from 850° to 1150° C. The mass of particles can be consolidated on the substrate by heat treatment for 1 to 48 hours, in particular for 5 to 24 hours. Usually, the mass of particles is consolidated on the substrate by heat treatment in an atmosphere containing 10 to 100 mol % O₂.

Further details on the application of inorganic colloidal and/or polymeric slurries on metal substrates are disclosed in U.S. Pat. No. 6,361,681 (de Nora/Duruz) and U.S. Pat. No. 6,365,018 (de Nora) and in PCT/IB03/01479 (Nguyen/de Nora).

Typically, the component of the invention is a component of a cell for the electrowinning of a metal such as aluminium, in particular a current carrying anodic component such as an active anode structure or an anode stem. The protective layer can be used not only to protect the current carrying component but also to form the electrochemically active part of the anodic component. Alternatively, the component of the invention may be another cell component exposed to molten electrolyte and/or cell fumes, such as a cell cover or a powder feeder. Examples of such cell components are disclosed in WO00/40781 and WO00/40782 (both de Nora), WO00/63464 (de Nora/Berclaz), WO01/31088 (de Nora) and WO02/070784 (de Nora/Berclaz). The applied layers on such cell components can be consolidated before use by heat treating the components over a cell.

Advantageously, the mass of particles can be consolidated by heat treating the cell component over the cell to form the protective layer. By carrying out the consolidation heat-treatment immediately before use, thermal shocks and stress caused by cooling and re-heating of the component between consolidation and use can be avoided.

Another aspect of the invention relates to a method of electrowinning a metal such as aluminium. The method comprises manufacturing by the above described method a current-carrying anodic component protected by a protective layer, installing the anodic component in a molten electrolyte containing a dissolved salt of the metal to electrowin, such as alumina, and passing an electrolysis current from the anodic component to a facing cathode in the molten electrolyte to evolve oxygen anodically and produce the metal cathodically.

The electrolyte can be a fluoride-based molten electrolyte, in particular containing fluorides of aluminium and sodium. Further details of suitable electrolyte compositions are for example disclosed in WO02/097167 (Nguyen/de Nora).

The cell can be operated with an electrolyte maintained at a temperature in the range from 800° to 960° C., in particular from 880° to 940° C.

Preferably, to reduce the solubility of metal-based cell components, an alumina concentration which is at or close to saturation is maintained in the electrolyte, particularly adjacent the anodic component.

An amount of iron species can also be maintained in the electrolyte to inhibit dissolution of the protective layer of the anodic component. Further details on such a cell operation are disclosed in the above mentioned U.S. Pat. No. 6,372,099.

The invention relates also to method of electrowinning a metal such as aluminium. The method comprises manufacturing by the above disclosed method a cover protected by a protective layer, placing the cover over a metal production cell trough containing a molten electrolyte in which a salt of the metal to electrowin is dissolved, passing an electrolysis current in the molten electrolyte to evolve oxygen anodically and metal cathodically, and confining electrolyte vapours and evolved oxygen within the cell trough by means of the protective layer of the cover.

Further features of cell covers are disclosed in U.S. Pat. No. 6,402,928 (de Nora/Sekhar), WO/070784 (de Nora/Berclaz) and PCT/IB03/02360 (de Nora/Berclaz).

A further aspect of the invention relates to a hematite-containing protective layer on a metal-based substrate for use in a high temperature oxidising and/or corrosive environment. The protective layer on the substrate is producible by the above described method.

Yet a further aspect of the invention concerns a cell for the electrowinning of a metal, such as aluminium, having at least one component that comprises a metal-based substrate covered with a hematite-containing protective layer as defined above.

### DETAILED DESCRIPTION

Examples of starting compositions of mass of particles for producing protective layers according to the invention are given in Table 1, which shows the weight percentages of the indicated constituents for each specimen A1-L1. Examples of alloy compositions of substrates for application of protective layers according to the invention are given in Table 2, which shows the weight percentages of the indicated metals for each specimen A2-O2.

TABLE 1

| | Fe₂O₃ | Fe | FeO | TiO₂ | ZrO₂ | ZnO | CuO | Al |
|---|---|---|---|---|---|---|---|---|
| A1 | 47 | 41 | — | 10 | — | — | 2 | — |
| B1 | 65 | 23 | — | 10 | — | — | 2 | — |
| C1 | 45 | 45 | — | — | 10 | — | — | — |
| D1 | 43 | 52 | — | — | — | — | 5 | — |
| E1 | 55 | 23 | — | 10 | 10 | — | 2 | — |
| F1 | 40 | 48 | — | 1 | 7 | — | 4 | — |
| G1 | 53 | 35 | — | 5 | — | 4 | 3 | — |
| H1 | 46 | 44 | — | — | — | 8 | 2 | — |
| I1 | 40 | — | 50 | 6 | — | — | 2 | 2 |
| J1 | 50 | — | 45 | — | — | — | 3 | 2 |
| K1 | 28 | 40 | 12 | 6 | — | — | 6 | 8 |
| L1 | 40 | 30 | 11 | — | — | — | — | 19 |

TABLE 2

| | Ni | Fe | Co | Cu | Al | Y | Mn | Si | C |
|---|---|---|---|---|---|---|---|---|---|
| A2 | 48 | 38 | — | 10 | 3 | — | 0.5 | 0.45 | 0.05 |
| B2 | 49 | 40 | — | 7 | 3 | — | 0.5 | 0.45 | 0.05 |
| C2 | 36 | 50 | — | 10 | 3 | — | 0.5 | 0.45 | 0.05 |
| D2 | 36 | 50 | — | 10 | 3 | 0.35 | 0.3 | 0.3 | 0.05 |
| E2 | 36 | 53 | — | 7 | 3 | — | 0.5 | 0.45 | 0.05 |
| F2 | 36 | 53 | — | 7 | 3 | 0.35 | 0.3 | 0.3 | 0.05 |
| G2 | 48 | 38 | — | 10 | 3 | 0.35 | 0.3 | 0.3 | 0.05 |
| H2 | 22 | 68 | — | 5.5 | 4 | — | 0.25 | 0.2 | 0.05 |
| I2 | 42 | 42 | — | 12 | 2 | 1 | 0.5 | 0.45 | 0.05 |
| J2 | 42 | 40 | — | 12.5 | 4 | 0.4 | 0.45 | 0.6 | 0.05 |
| K2 | 45 | 44 | — | 7 | 3 | — | 0.5 | 0.45 | 0.05 |
| L2 | 30 | 69 | — | — | — | — | 0.5 | 0.45 | 0.05 |
| M2 | 25 | 65 | 7 | 1 | 1 | — | 0.5 | 0.45 | 0.05 |
| N2 | 59 | 40 | — | — | — | — | 0.5 | 0.45 | 0.05 |
| O2 | 50 | 47.4 | — | — | — | 1.7 | 0.35 | 0.5 | 0.05 |

### COMPARATIVE EXAMPLE

An anode was manufactured from an anode rod of diameter 20 mm and total length 20 mm made of a cast alloy having the composition of sample A2 of Table 2. The anode rod was supported by a stem made of an alloy containing nickel, chromium and iron, such as Inconel, protected with an alumina sleeve. The anode was suspended for 16 hours over a molten cryolite-based electrolyte at 925° C. whereby its surface was oxidised.

Electrolysis was carried out by fully immersing the anode rod in the molten electrolyte. The electrolyte contained 18 weight % aluminium fluoride (AlF₃), 6.5 weight % alumina (Al₂O₃) and 4 weight % calcium fluoride (CaF₂), the balance being cryolite (Na₃AlF₆).

The current density was about 0.8 A/cm² and the cell voltage was at 3.5-3.8 volt throughout the test. The concentration of dissolved alumina in the electrolyte was maintained during the entire electrolysis by periodically feeding fresh alumina into the cell.

After 50 hours electrolysis was interrupted and the anode extracted. Upon cooling the anode was examined externally and in cross-section.

The anode's outer dimensions had remained substantially unchanged. The anode's oxide outer part had grown from an initial thickness of about 70 micron to a thickness after use of about up to 500 micron.

Samples of the used electrolyte and the product aluminium were also analysed. It was found that the electrolyte contained 150-280 ppm nickel and the product aluminium contained roughly 1000 ppm nickel.

### EXAMPLE 1

An aluminium electrowinning anode was prepared according to the invention as follows:

A slurry for coating an anode substrate was prepared by suspending in 32.5 g of an aqueous solution containing 5 weight % polyvinyl alcohol (PVA) 67.5 g of a particle mixture made of hematite Fe₂O₃ particles, iron metal particles, TiO₂ particles and CuO particles (with particle size of −325 mesh, i.e. smaller than 44 micron) in a weight ratio corresponding to sample A1 of Table 1.

An anode substrate made of the alloy of sample A2 of Table 2 was covered with ten layers of this slurry that were applied with a brush. The applied layers were dried for 10 hours at 140° C. in air and then consolidated at 1100° C. for 24 hours to form a protective hematite-based coating which had a thickness of 0.4 to 0.45 mm.

During consolidation, the Fe₂O₃ particles were sintered together into a porous matrix with a volume contraction. The TiO₂ particles and CuO particles were dissolved in the sintered Fe₂O₃. Simultaneously, the iron metal particles were successively oxidised into FeO (ferrous oxide), Fe₃O₄ (magnetite) and Fe₂O₃ (hematite) with a volume expansion compensating the above volume contraction and filling the porous hematite matrix.

The formation of the hematite from the ferrous oxide resulted in a volume expansion such that the thus formed hematite filled the porous sintered hematite matrix and inhibited formation of cracks by contraction of the pores of the hematite matrix during sintering that would be formed in the absence of iron metal in the particle mixture. The hematite-containing protective layer was thus dense and crack-free and able to inhibit diffusion from and to the metal-based substrate.

Underneath the coating, an integral oxide scale mainly of iron oxide had grown from the substrate during the heat treatment and sintered with iron oxide and titanium oxide from the coating to firmly anchor the coating to the substrate. The sintered integral oxide scale contained titanium oxide in an amount of about 10 metal weight %. Minor amounts of copper, aluminium and nickel were also found in the oxide scale (less that 5 metal weight % in total).

### EXAMPLE 2

An anode was prepared as in Example 1 by covering an iron-alloy substrate with layers of a slurry containing a particle mixture of Fe₂O₃, Fe, TiO₂ and CuO.

The applied layers were dried and then consolidated by suspending the anode for 36 hours over a cryolite-based electrolyte at about 925° C. The electrolyte contained 18 weight % aluminium fluoride (AlF₃), 6.5 weight % alumina (Al₂O₃) and 4 weight % calcium fluoride (CaF₂), the balance being cryolite (Na₃AlF₆).

Upon consolidation of the layers, the anode was immersed in the molten electrolyte and an electrolysis current was passed from the anode to a facing cathode through the alumina-containing electrolyte to evolve oxygen anodically and produce aluminium cathodically. A high oxygen evolution was observed during the test. The current density was about 0.8 A/cm² and the cell voltage was stable at 3.1-3.2 volt throughout the test.

Compared to an uncoated anode, i.e. the anode the comparative Example, the coating of an alloy-anode with an oxide protective layer according to the invention led to an improvement of the anode performance such that the cell voltage was stabilised and also reduced by 0.4 to 0.6 volt, which corresponds to about 10 to 20%, thus permitting tremendous energy savings.

After 50 hours, the anode was extracted from the electrolyte and underwent cross-sectional examination.

The dimension of the coating had remained substantially unchanged. However, TiO₂ had selectively been dissolved in the electrolyte from the protective coating. The integral oxide layer of the anode substrate had grown to a thickness of 200 micron, i.e. at a much slower rate than the oxide layer of the uncoated anode of the Comparative Example.

Samples of the used electrolyte and the product aluminium were also analysed. It was found that the electrolyte contained less that 70 ppm nickel and the produced aluminium contained less than 300 ppm nickel which is significantly lower than with the uncoated anode of the Comparative Example. This demonstrated that the protective coating of the invention constituted an efficient barrier reducing nickel dissolution from the anode's alloy inhibiting contamination of the product aluminium by nickel.

### EXAMPLE 3

Examples 1 and 2 can be repeated using different combinations of coating compositions (A1-L1) selected from Table 1 and metal alloy compositions (A2-O2) selected from Table 2.

While the invention has been described in conjunction with specific embodiments thereof, it is evident that alternatives, modifications, and variations will be apparent to those skilled in the art.

For example, in a modification of the invention, all the materials described above for forming the hematite-containing protective layers can alternatively be shaped into a body and sintered to form a massive component, in particular an aluminium electrowinning anode, made of the hematite-containing material. Such a component can be made of oxides or, especially when used as a current carrying component, of a cermet having a metal phase for improving the electrical conductivity of the material.

1. A method of forming a hematite-containing protective layer on a metal-based substrate for use in a high temperature oxidising and/or corrosive environment: comprising:
applying onto the substrate a mass of particles comprising hematite (Fe₂O₃) and one of:
(a) iron metal (Fe) with a weight ratio Fe/Fe₂O₃ of at least 0.3 and preferably no more than 2, in particular in the range from 0.8 to 1.4; or
(b) ferrous oxide (FeO) with a weight ratio FeO/Fe₂O₃ of at least 0.35 and preferably no more than 2.5, in particular in the range from 0.9 to 1.7; and
(c) iron metal (Fe) and ferrous oxide (FeO), with weight ratios Fe/Fe₂O₃ and FeO/Fe₂O₃ that are in pro rata with the ratios of (a) and (b); and
consolidating the applied mass of particles to form the hematite-containing protective layer by heat treating the mass of particles to:
1) oxidise when present the iron metal (Fe) into ferrous oxide (FeO);
2) sinter the hematite to form a porous sintered hematite matrix; and
3) oxidise into hematite (Fe₂O₃) the ferrous oxide (FeO), present in the mass of particles as such and/or in the form of the oxidised iron metal, to fill the sintered hematite matrix.

2. The method of claim 1, wherein the mass of particles further comprises at least one additive selected from oxides of titanium, yttrium, ytterbium, tantalum, manganese, zinc, zirconium, cerium and nickel and/or heat-convertible precursors thereof.

3. The method of claim 2, wherein the additive(s) is/are present in the protective layer in an amount of 1 to 50 weight %, preferably 1 to 30 weight %, even more preferably 5 to 15 weight %.

4. The method of any preceding claim, wherein the protective layer further comprises one or more metals selected from Cu, Ag, Pd, Pt, Co, Cr, Al, Ga, Ge, Hf, In, Ir, Mo, Mn, Nb, Os, Re, Rh, Ru, Se, Si, Sn, Ti, V, W, Li, Ca, Ce and Nb and oxides thereof, which are added as such and/or as precursors to the mass of particles.

5. The method of claim 4, wherein the protective layer comprises said at least one metal and/or oxide thereof, in particular copper and/or copper oxide, in a total amount of 1 to 15 weight %, preferably from 1 to 10 weight, in particular from 1 to 5 weight %.

6. The method of any preceding claim, wherein the mass of particles is made of particles that are smaller than 75 micron, preferably smaller than 50 micron, in particular from 5 to 45 micron.

7. The method of any preceding claim, wherein the metal-based substrate is metallic, a ceramic, a cermet or metallic with an integral oxide layer.

8. The method of any preceding claim, wherein the metal-based substrate comprises at least one metal selected from chromium, cobalt, hafnium, iron, molybdenum, nickel, copper, niobium, platinum, silicon, tantalum, titanium, tungsten, vanadium, yttrium and zirconium.

9. The method of claim 8, wherein the metal-based substrate comprises an alloy of iron, in particular an iron alloy containing nickel and/or cobalt.

10. The method of claim any preceding claim, comprising oxidising the surface of a metallic substrate to form an integral anchorage layer thereon to which the protective layer is bonded by sintering during heat treatment, in particular an integral layer containing an oxide of iron and/or another metal, such as nickel, that is sintered during heat treatment with iron oxide from the mass of particles.

11. The method of any preceding claim, wherein the mass of particles is applied as a slurry onto the substrate.

12. The method of claim 11, wherein the slurry comprises an organic binder, in particular a binder selected from polyvinyl alcohol, polyvinyl acetate, polyacrylic acid, hydroxy propyl methyl cellulose, polyethylene glycol, ethylene glycol, hexanol, butyl benzyl phthalate and ammonium polymethacrylate.

13. The method of claim 11 or 12, wherein the slurry comprises an inorganic binder, in particular a colloid, such as a colloid selected from lithia, beryllium oxide, magnesia, alumina, silica, titania, vanadium oxide, chromium oxide, manganese oxide, iron oxide, gallium oxide, yttria, zirconia, niobium oxide, molybdenum oxide, ruthenia, indium oxide, tin oxide, tantalum oxide, tungsten oxide, thallium oxide, ceria, hafnia and thoria, and precursors thereof such as hydroxides, nitrates, acetates and formates thereof, all in the form of colloids; and/or an inorganic polymer, such as a polymer selected from lithia, beryllium oxide, alumina, silica, titania, chromium oxide, iron oxide, nickel oxide, gallium oxide, zirconia, niobium oxide, ruthenia, indium oxide, tin oxide, hafnia, tantalum oxide, ceria and thoria, and precursors thereof such as hydroxides, nitrates, acetates and formates thereof, all in the form of inorganic polymers.

14. The method of claim 13, wherein the inorganic binder is sintered during the heat treatment with an oxide of an anchorage layer which is integral with the metal-based substrate to bind the protective layer to the metal-based substrate.

15. The method of any preceding claim, wherein the mass of particles is consolidated on the substrate by heat treatment at a temperature in the range from 800° to 1400° C., in particular from 850° to 1150° C.

16. The method of any preceding claim, wherein the mass of particles is consolidated on the substrate by heat treatment for 1 to 48 hours, in particular for 5 to 24 hours.

17. The method of any preceding claim, wherein the mass of particles is consolidated on the substrate by heat treatment in an atmosphere containing 10 to 100 mol % O₂.

18. The method of any preceding claim for manufacturing a component of a metal electrowinning cell, in particular an aluminium electrowinning cell, which during use is exposed to molten electrolyte and/or cell fumes and protected therefrom by said protective layer.

19. The method of claim 18 for manufacturing a current carrying anodic component, in particular an active anode structure or an anode stem.

20. The method of claim 18 for manufacturing a cover.

21. The method of any one of claims 18 to 20, comprising consolidating the mass of particles to form the protective layer by heat treating the cell component over the cell.

22. A method of electrowinning a metal, such as aluminium, comprising manufacturing a current-carrying anodic component protected by said protective layer as defined in claim 19, installing the anodic component in a molten electrolyte containing a dissolved salt of the metal to electrowin such as alumina, and passing an electrolysis current from the anodic component to a facing cathode in the molten electrolyte to evolve oxygen anodically and produce the metal cathodically.

23. The method of claim 22, wherein the electrolyte is a fluoride-based molten electrolyte, in particular containing fluorides of aluminium and sodium.

24. The method of claim 22 or 23, comprising maintaining the electrolyte at a temperature in the range from 800° to 960° C., in particular from 880° to 940° C.

25. The method of any one of claims 22 to 24, comprising maintaining in the electrolyte, particularly adjacent the anodic component, an alumina concentration which is at or close to saturation.

26. The method of any one of claims 22 to 25, comprising maintaining an amount of iron species in the electrolyte to inhibit dissolution of the protective layer of the anodic component.

27. A method of electrowinning a metal, such as aluminium, comprising manufacturing a cover protected by said protective layer as defined in claim 20, placing the cover over a metal electrowinning cell trough containing a molten electrolyte in which a salt of the metal to electrowin is dissolved, passing an electrolysis current in the molten electrolyte to evolve oxygen anodically and the metal cathodically, and confining electrolyte vapours and evolved oxygen within the cell trough by means of the protective layer of the cover.

28. A hematite-containing protective layer on a metal-based substrate for use in a high temperature oxidising and/or corrosive environment, producible by the method of any one of claims 1 to 21, which is dense and at least substantially crack-free.

29. A cell for the electrowinning of a metal, such as aluminium, having at least one component that comprises a metal-based substrate covered with a hematite-containing protective layer as defined in claim 28.

30. A method of forming a hematite-containing body for use in a high temperature oxidising and/or corrosive environment: comprising:
providing a mass of particles comprising hematite (Fe₂O₃) and one of:
(a) iron metal (Fe) with a weight ratio Fe/Fe₂O₃ of at least 0.3 and preferably no more than 2, in particular in the range from 0.8 to 1.4; or
(b) ferrous oxide (FeO) with a weight ratio FeO/Fe₂O₃ of at least 0.35 and preferably no more than 2.5, in particular in the range from 0.9 to 1.7; and
(c) iron metal (Fe) and ferrous oxide (FeO), with weight ratios Fe/Fe₂O₃ and FeO/Fe₂O₃ that are in pro rata with the ratios of (a) and (b);
shaping the mass of particles into the body; and
consolidating the body by heat treating the mass of particles to:
1) oxidise when present the iron metal (Fe) into ferrous oxide (FeO);
2) sinter the hematite to form a porous sintered hematite matrix; and
3) oxidise into hematite (Fe₂O₃) the ferrous oxide (FeO), present in the mass of particles as such and/or in the form of the oxidised iron metal, to fill the sintered hematite matrix.

31. The method of claim 30, incorporating any of the features of claims 2 to 6 and/or wherein the mass of particles is provided in a slurry and consolidated as defined in any one of claims 12 to 13 or 15 to 17.

32. The method of claim 30 or 31, for manufacturing a component as defined in claims 18 to 20.
